(19) United States
(12) Patent Application Publication
(10) Pub. No.: US 2005/0246349 A1
(43) Pub. Date: Nov. 3, 2005

(54) Method for data flow control in a packet data transmission system and a device for data flow control in a packet data transmission system

(76) Inventors: Marcin Wielgosz, Klaisz (US); Kamil Burzynski, Zielona (US); Marek Gruszcynski, Zielona Gora (US); Miroslaw Kusiak, Zielona Gora (US); Andrzej Nadachowski, Wielkopolski (US); Janusz Ogrodowczyk, Nowa Sol (US); Jacck Szpakowski, Zielona Gora (US)

Correspondence Address: SCHOLL PATENT AGENCY, INC.;DR. MATTHIAS SCHOLL, 14781 MEMORIAL DRIVE, SUITE 1319, HOUSTON, TX, 77079, US

(21) Appl. No.: 10/525,464

(22) PCT Filed: Aug. 25, 2003
(86) PCT No.: PCT/PL03/00083

§ 371 Date: Feb. 24, 2005

(30) Foreign Application Priority Data
Aug. 25, 2002 (PL) P.355743

(51) Int. Cl. G06F 17/30

(52) U.S. Cl. 707/100

(57) ABSTRACT

The objects of the invention are a method for control of data flow in a packet data transmission and a device for control of data flow in a packet data transmission, both being applicable for example in systems of data transmission in formats used in digital television. The method according to the invention is based on the fact that to a data processing device, comprising a network of nodes in the form of input nodes (IN1-INn), output nodes (OUT1-OUTn) and intermediate nodes such as data processing nodes (PROC1-PROCn) or multiplexers (MUX1-MUXo), the nodes being connected as a free-defined structure, signals are supplied to input nodes (IN1-INn) and from the data packets retrieved from these nodes (IN1-INn) transmission units are created. Whenever a packet is available at the node input (MUX1-MUXo, PROC1-PROCn, OUT1-OUTn), a check is made whether the general rules (R) apply to a given unit and in case of a positive result of this check, the commands, determined by these rules, are executed and then a check is made whether the input rules apply to a given unit. If they do, the commands, determined by these rules, are executed and then the node function is preformed (IN1-INn, MUX1-MUXo, PROC1-PROCn, OUT1-OUT1n), followed by a check if the output rules apply to a give unit. In the output nodes (OUT1-OUTn) the packets are extracted from transmission units. The method according to the invention is performed by a device disclosed in the application.

The object of the present invention is a method for data flow control in a packet data transmission system, applicable for example to systems of data transmission in formats used in digital television.

There are known and commonly used networks, having packet data transmission, using packets encapsulation with additional fields. An example of such a model, known from computer networks, is the OSI (Open Systems Interconnection) model, where encapsulating lower layers packets creates upper layers packets.

There are also known methods for filtering and manipulation of packets, flowing through a given network. For example, commonly used firewalls software (e.g. ipchains from Linux) enable to set packet processing rules, for example taking into account their source, destination or type, depending on whether packets are incoming or outgoing ones. However, the rules available in present software allow mainly filtering and directing packets to appropriate outputs, but do not allow conversion of data that the packets carry.

From the European patent application EP 1217838 a control system is known that allows changing packet identifiers (PID) of incoming data. Data is only analyzed and encapsulated.

It is the object of the present invention to create a method for control of data flow in a packet data transmission system and a device for control of data flow in a system, where the data flow control components and packet manipulation components are nodes. The nodes may be in a form of input nodes (supplying data in a required format), multiplexing nodes (joining several transmission unit streams into one stream) or output nodes (performing transmission unit conversion to a given output format). Besides their basic functions, such as conversion and multiplexing, each node can be assigned rules characterizing data management commands, which are to be applied to transmission units, flowing through the node.

The rules define transmission units to be modified, by specifying a label, a type or a size of a packet included in a given transmission unit, and also define methods of execution of such modifications by providing an appropriate command. The rules may also determine a need for a conversion of specific packets in specific transmission units to a different format. The packets entering the system are converted into transmission units, which are created by encapsulating the input packets by adding a label, a field determining the packet type and a field determining the packet size. The label is used to mark the input, which the transmission unit was retrieved from. Unit labels can be modified in every system node.

The method for control of data flow in a packet data transmission system according to the invention is based on the fact that data is supplied to the input nodes of the processing system comprising a network of nodes in the form of input nodes, output nodes and intermediate nodes such as data processing nodes or multiplexers, where the nodes are connected in a user-defined structure. The data supplied to the input nodes of the system is converted into transmission units, and each of the nodes is assigned input and output rules, as well as general rules.

Whenever a packet is available at the node input, it is checked whether the general rules apply to this unit and in case of a positive result of this check, the commands, determined by these rules, are executed and then it is checked whether the input rules apply to this unit. If yes, the commands, determined by these rules, are executed and then the node function is performed, followed by a check whether the output rules apply to this unit. In the output nodes, the packets are extracted from transmission units, which are created by adding a label field, a type field and/or a size field to the packet. In case when a rule is a conversion rule, it is checked whether a given conversion algorithm requires additional rules being present. If it does and the additional rules are not present, the packet is rejected. The packets, to which the given rule applies, are defined by their label, type, size or similar parameters.

The device for control of data flow in a packet data transmission system according to the present invention, which uses the above described method for control of data flow, comprises at least two input nodes, processing supplied data, forming transmission units and provisionally converting input packet signals from a given format to another, which is performed on the basis of output rules set for input nodes. The outputs of input nodes are connected to other system nodes, including at least one multiplexer and/or at least one data processing node and/or at least one output node. The nodes process the flowing transmission units based on the general, input and output rules set for nodes according to the data flow control method described above. The outputs of the multiplexers and data processing nodes are connected to other multiplexers or data processing nodes or output nodes. The output nodes are the final nodes in the system and in these nodes the transmission units are converted to the packets they carry.

The above-described device and method for control of data flow in a packet data transmission system create a possibility of a convenient control of data flow through the system. The essential features are the possibility to encapsulate data by adding a label, a type and a packet size fields in the system input nodes and the possibility of removing this information in the output nodes as well as extended possibilities of packet processing in the system nodes allowing packet processing at every input and output of every node, manipulating the packets according to the general rules or local rules assigned to particular inputs and outputs of system nodes, distinguishing packets based on their label, type and/or size and finally filtering packets and their conversion to a given format in every system node.

The essence of the described device and method is that every node has a functionality extended with transmission unit processing procedures, that are based on general rules or rules defined for particular inputs or outputs of a given node. The disclosed method of processing allows supplying data to the transmission system in various formats (for example in a digital television system it may be audio and/or video frames in MPEG format, a private section of MPEG format or any given data in the form of graphic files, applications or data files) and combining it into an output stream. In case of a transmission system supplying data in MPEG format, it is possible to add to this stream data in other formats on the basis of described conversion rules, allowing the data to be written into packets having a predetermined structure and identification fields, for example a PID field.

The object of the present invention is shown as an exemplary embodiment in a drawing where

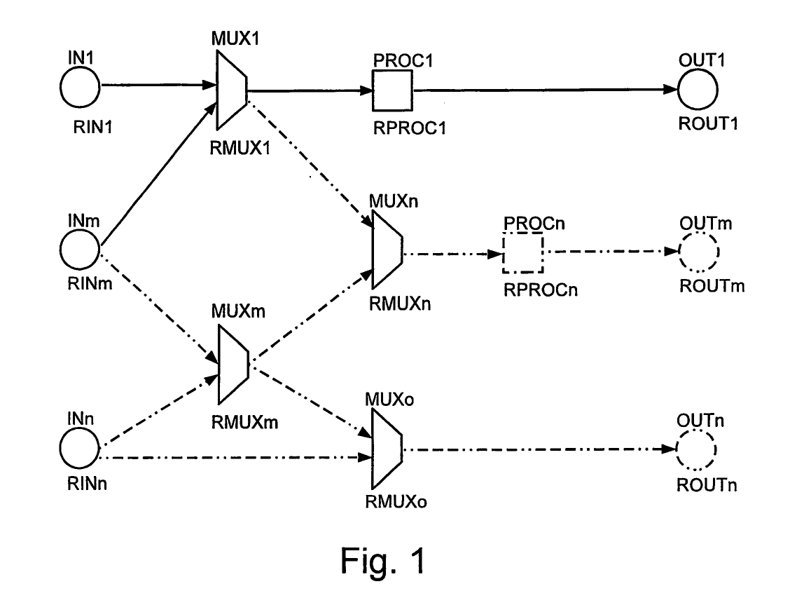

FIG. 1 shows a general block structure of a data flow control device in a packet data transmission system,

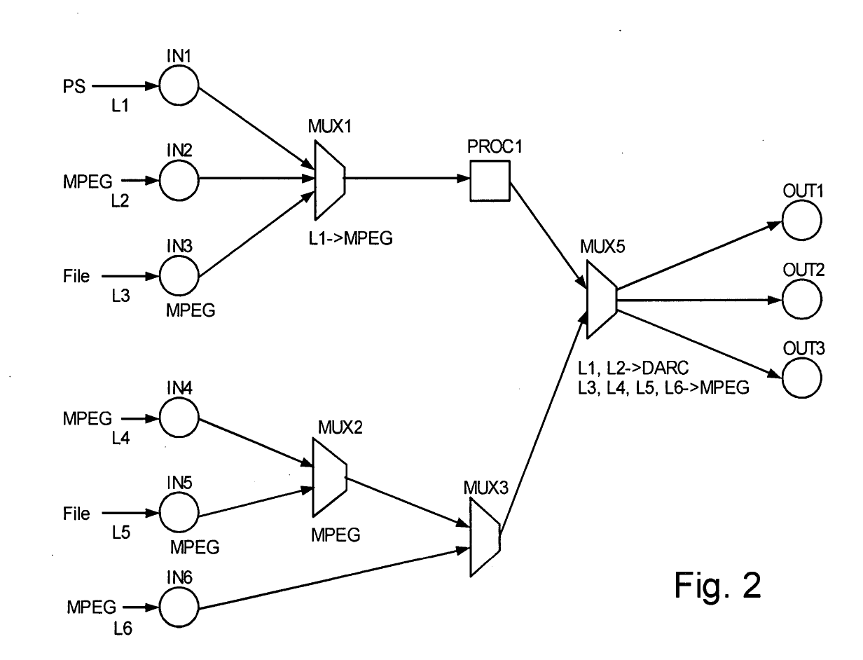

FIG. 2 shows an exemplary block diagram of a data flow control device in a packet data transmission system,

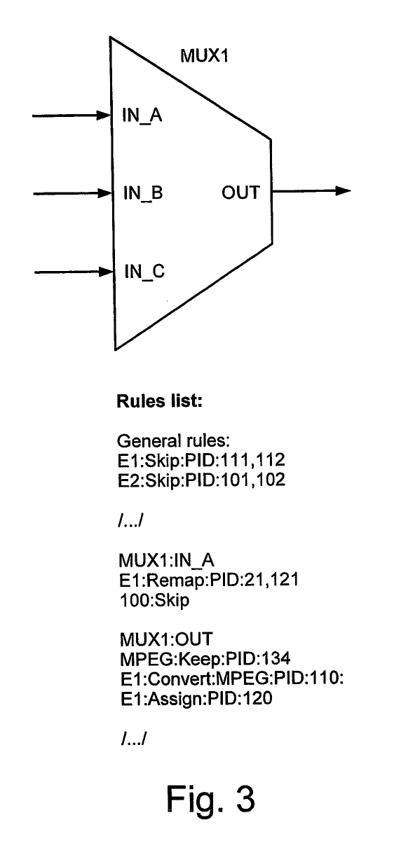

FIG. 3, shows an exemplary node of a single multiplexer and a list of rules assigned to it. The following figures of the drawing show a method for control of data flow according to the invention

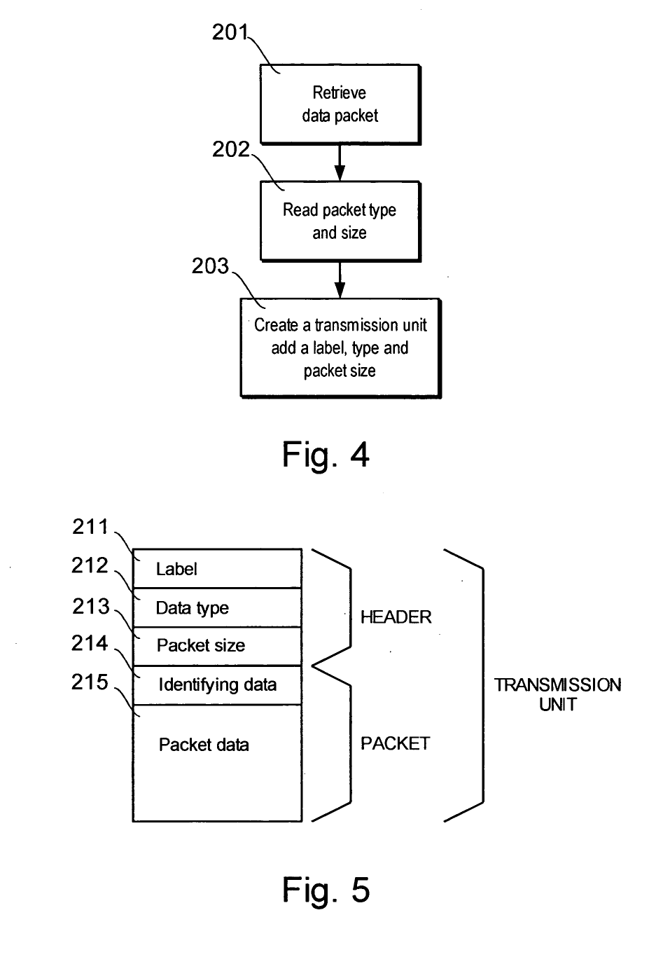

FIG. 4 and FIG. 5 show an algorithm of transmission unit creation in an input node and a structure of a transmission unit, respectively.

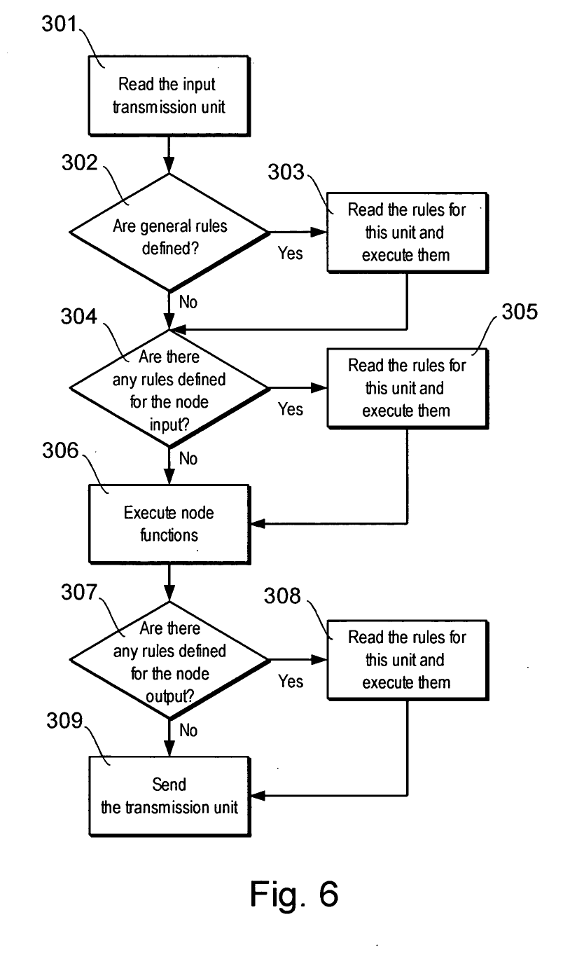

FIG. 6 to FIG. 9 show a single node operation algorithm, a rules management algorithm, an algorithm of execution of commands defined by rules and algorithm of transmission unit data conversion to a given output format, respectively.

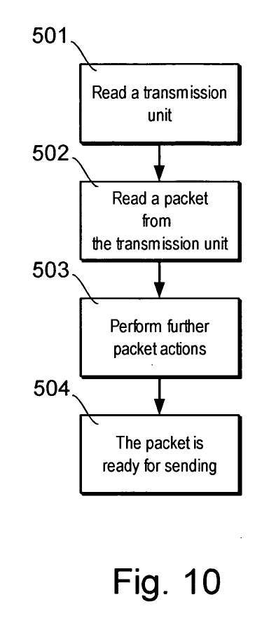

FIG. 10 shows an algorithm of output nodes operation.

As shown in FIG. 1 of the drawing, an exemplary structure of a device for control of data flow in a packet data transmission system is a network of input nodes IN1-INn, output nodes OUT1-OUTn and intermediate nodes that are data processing nodes PROC1-PROCn or multiplexers MUX1-MUXo. These nodes are connected in a user-defined structure. Signals are supplied to input nodes IN1-INn and from data packets retrieved from these nodes IN1-INn transmission units are created. Every node IN1-INn, PROC1-PROCn, MUX1-MUXo and OUT1-OUTn has input rules RIN1-RINn, RPROC1-RPROCn, RMUX1-RMUXo and output rules ROUT1-ROUTn assigned to it beforehand. The system also has general rules defined. Moreover, in the input nodes IN1-INn the transmission units are assigned labels, which identify the input node IN1-INn, from which a given unit originates.

FIG. 2 provides further details for network structure and presents an exemplary block diagram of a device for control of data flow in a packet data transmission system. According to the figure, the device comprises six input nodes IN1-IN6, processing retrieved data, forming from them transmission units and provisionally converting signals of input packets from a one format to another. The outputs of the first three input nodes IN1-IN3 are connected to inputs of the first multiplexer MUX1, the outputs of the further two input nodes IN4-IN5 are connected to the inputs of the second multiplexer MUX2 and the output of the last input node IN6 is connected to one of the inputs of the next multiplexer MUX3, to the second input of which the output signal from the second multiplexer MUX2 is transmitted. The output of the first multiplexer MUX1 is connected to the input of the processing node PROC1, which performs programmed actions on the data it receives and its output signal is passed to one of the inputs of yet another multiplexer MUX5, to the second input of which the output signal from multiplexer MUX3 is transmitted. The multiplexer MUX5 output signals are passed to the three output nodes OUT1-OUT3, which according to set rules block or pass packets having predetermined labels, for example in order to adapt them to a given service that the output node prepares data for.

The method for control of data flow in a packet data transmission system is realized on the basis of subsequent procedures, algorithms of which will be described in details below.

The data entering the transmission system is processed in the input nodes IN1-IN6, in which transmission units are created from the input data. In the nodes IN1-IN6 a provisional conversion of packets may be carried out from one format to another. For example, the node IN3 has MPEG format set as the output format and the inputs are data files, so in this node a conversion from data files to MPEG format is performed. Similar conversion is carried out in the node IN5.

In the input nodes IN1-IN6 the packets are assigned labels, which may later be useful to determine from which of the nodes IN1-IN6 the data comes. Accordingly, IN1 assigns L1 to all its packets; IN2 assigns L2 and so on, to the L6 being assigned to all IN6 packets. It is also possible to define other operations on packets, for example changing identification data or omitting all or certain packets, which allows disabling a given input. The transmission units from input nodes IN1, IN2 and IN3 are combined into one stream by the multiplexer MUX1, for which rules, such as for example passing or blocking units of a given label, have been previously set. The output format of units of L1 label from node MUX1 is MPEG, so data originating from mode IN1 (PS—Private Section—a data format related to MPEG format) will be converted to MPEG packets. The output data of the multiplexer MUX1 are sent to the processing node PROC1, where programmed actions are performed on retrieved data.

The node PROC1 has also its rules assigned. Its output signal is passed to the multiplexer MUX5. The units labeled L1 and L2 that go via MUX5 are converted to the DARC (Data Radio Channel) format, while the remaining units (L3, L4, L5 and L6) are converted to the MPEG format if such conversion is required. Similar conversion rules are set for packets having certain data, type or size. The multiplexer MUX5 output data is passed to three different output nodes OUT1, OUT2 and OUT3. These nodes can also have predetermined sets of data processing rules such as for example blocking or passing packets having certain labels in order to adapt them to a given service, for which the output node prepares data.

An exemplary multiplexer node and a fragment of rules list are presented in FIG. 3 of the drawing. A more detailed description of rules is presented in the following fragment of the text; here they are presented as examples only. The multiplexer has three inputs IN_A, IN_B, IN_C and an output OUT. There are general rules defined on the rules list:
Skipping packets having PID equal to 111 and 112 and labeled with E1
Skipping packets having PID equal to 101 and 102 and labeled with E2
   And rules assigned to the IN_A input of the multiplexer:
Remapping of the PID field from 21 to 121 for packets labeled E1
Skipping packets that have size greater than 100
   And rules assigned to the OUT output of the multiplexer:
Keeping, in the output stream, packets of PID equal to 134
Converting packets labeled E1 to MPEG format
Assigning all E1 packets a PID field value of 120

The algorithm of processing of system input data and the data flowing inside the system will now be described. In the input nodes the input data is encapsulated to form a transmission unit, which is presented in FIG. 4 and the structure of the transmission unit is shown in FIG. 5. The content of the transmission unit can be converted to a given format, which can take place in any node, according to the algorithm shown in FIG. 6. For the ease of data flow control, uniform packets, in the form of transmission units, are created in which packets of any format can be transmitted.

The transmission unit comprises a data packet and a unit header (FIG. 5). The packet structure may be of any kind. However, it is assumed that a typical packet comprises a block 214 with identification data (packet header) and a block 215, which is the actually carried data. The packet header 214 may comprise any number of fields with identification data, which are identified by the field names.

In case of an MPEG packet, the identifying block includes a PID field (Packet Identifier). The unit header comprises a label 211, a field determining packet type 212 and a unit data size field 213. Every input node can assign units a separate label 211, on the basis of which a data source can be identified. The 212 field, defining the data type, is useful for example for blocking or passing packets of certain type only, in order to check whether a given rule can be applied to a transmission unit with a packet of a given type.

The transmission units are created according to FIG. 4. In the first step 201, the input data is acquired in a form of packets (with or without a header, as pure data packets). If the input data is supplied in the form of a file of a large size, the file-splitting procedure must be invoked in advance. Next, in step 202, the packet type and size are read. The last step 203 involves adding to the read packet a unit header, comprising a label (initially empty), a type and a size.

Explanation of Rules.

The rule syntax is as follows:

Unit identifier+command+arguments

The first part, unit identifier, identifies transmission units, to which the command applies. It may identify a transmission unit label as well as type or size of the packet that the unit carries.

The last part, arguments, defines parameters of a given command. These parameters may identify specific packets of units identified by a unit identifier. The packet header fields may be defined here, for example for an MPEG packet the PID values can be set.

Exemplary commands and their arguments are presented in the table below:

Command Description

Label The given label will be assigned to all transmission units processed in a node. If the units already have a label, it will be overwritten by the one specified in the argument.

Filter:FIELD1:100,101,102 Transmission units having packets with a header field FIELD1 value equal to 100, 101 or 102 will be filtered (their packets will be replaced with empty packets)

Filter_range:FIELD1:100,150 Transmission units having packets with a header field FIELD1 of a value between 100 and 150 will be filtered (their packets will be replaced with empty packets)

Remap:FIELD1:21,101,22,102 If the transmission units include packets with header fields FIELD1 of a value 21 or 22, the value of that field will be changed to 101 or 102, respectively.

Keep:FIELD1:101,102,157 Only transmission units with packets having header field FIELD1 value equal to 101,102 or 157 will be output.
The remaining packets will be replaced with empty ones.

Keep_range:FIELD1:101,150 Only transmission units with packets having header field FIELD 1 of value between 101 and 150 will be output.
The remaining packets will be replaced with empty ones.

Skip:FIELD1:101,126,178 Transmission units with packets having header field FIELD1 value equal to 101, 126 and 178 will be skipped (removed from the stream).

Skip_range:FIELD1:101,150 Transmission units with packets having header field FIELD1 of value between 101 and 150 will be skipped (removed from the stream).

Assign:FIELD1:101 The value of field FIELD1 in all packets having that field in the header will be set to 101.

Convert:FORMAT:FIELD1:101 Transmission units with packets having header field FIELD1 value equal to 101 will be converted to the FORMAT (for example MPEG, DARC) format.

If no arguments are defined for a given command, the command will apply to all packets included in the transmission units. This does not apply to Change and Assign commands, which must have their arguments present. For example, the Skip command without arguments will remove from a stream all units identified with unit identifier. The removal of these units may be achieved also by setting appropriate identification data range from the minimum to the maximum value. If the system transmits packets in MPEG format, the identifying data can define for example a PID of transmitted packets. In such a case, an exemplary command would have the form of: Assign:PID:101.

In order to execute a command for certain units, they must be identified with a:
Label
Packet type
Minimum packet size

Or a combination of two or three of the above features.

For example, a rule:

LabelA:Assign:FIELD1:101

will set the field FIELD1 of the packet header to 101, provided the unit label is “LabelA”.

Another example:

MPEG:Assign:FIELD1:101

Will set packet header field FIELD1 to 101 for all packets in MPEG format, irrespective of their label (determining the source node of a given unit).

Another example is:

100:Filter

As a result, all packets having size greater than 100 will be replaced with empty ones.

An example of a syntax combining two features:

LabelA:100:Filter

As a result, all packets having size greater than 100 will be replaced with empty ones, provided the unit label equals to “LabelA”.

The most complex command is Convert. It converts packets to a format defined in the command argument. If no other arguments are provided, the conversion will apply to all packets. However, as additional parameters there can be defined packet header fields, identifying the packets, which the conversion will apply to. For example the command: LabelA:Convert:MPEG:PID:110 executes conversion of packets having PID equal to 110, carried in units labeled with “LabelA”, to an MPEG format.

The conversion itself is performed by an appropriate function. Before the conversion, the procedure for managing rules reads the format of the packet, which is to be converted and then checks if there is a function that performs the conversion from a given format to another one. If not, the packet is rejected. If yes, the procedure checks whether additional actions need to be performed on the packet after conversion, for example assigning new values to header fields, such as setting a new PID value. If yes, it is checked whether such commands are set. If not, the packet is rejected. If yes, the conversion is executed and followed by execution of commands described by the rules.

Rules for a given node can also be assigned to a particular input or output of this node. It is essential especially in nodes, which have more than one input or output. An example of such a node is a multiplexer. Rules for a multiplexer can be set for each input, which allows, for example, rejecting certain transmission units. Specifying different rules for different inputs allows saving system processing power, since the rules will be checked only for a given input. The multiplexer output can also have its own rules assigned. In such a case they will apply to all of the multiplexed data.

There are, however, two exceptions. The input nodes can have rules set for outputs only, because there are no transmission units on their inputs. Similarly, only the inputs of output nodes can have rules set, because there are no transmission units on the outputs.

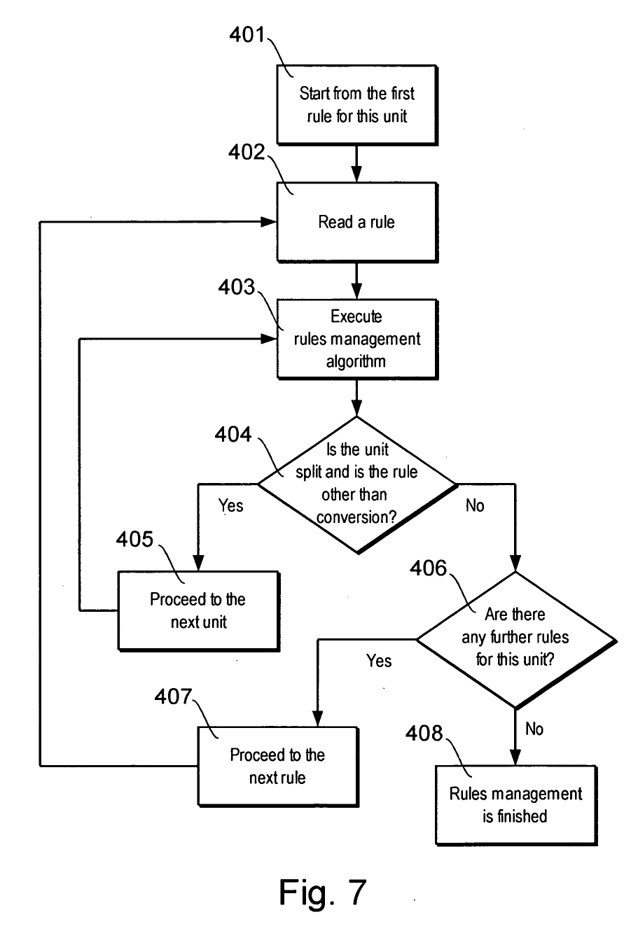

A general node operation algorithm is shown in FIG. 6 of the drawing. The first step, for a node, is to read the input data 301. Then a check is made whether general rules are defined 302. The general rules are checked for input data. Therefore, if the general rules cause skipping of certain units, other rules or functions of a given node will not process these units. Next the rules management algorithm is executed 303, which receives a list of rules of a given node as its input data. The algorithm is shown in FIG. 7 of the drawing. Then a check is made whether there are any input rules, for the input, which the read transmission unit originates from 304. If yes, the rules management algorithm is executed 305, by passing to it a list of rules that apply to a given unit. Next, the node functions are executed 306, such as data processing or multiplexing. Then a check is made whether there are any output rules, for the output, which the transmission unit will be directed to 307. If yes, the rules algorithm is executed 308, by passing to it a list of rules that apply to a given unit. The last step 309, involves sending the transmission unit. It is obvious, as it has already been mentioned, that for the output nodes the steps 302-305 are not performed and for the input nodes the steps 307-308 are not performed, since there would be no transmission units for them.

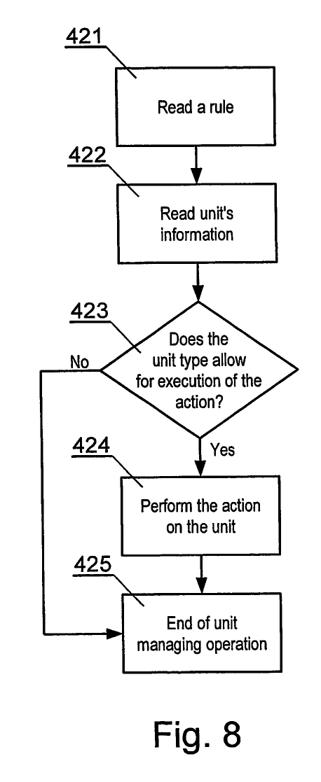

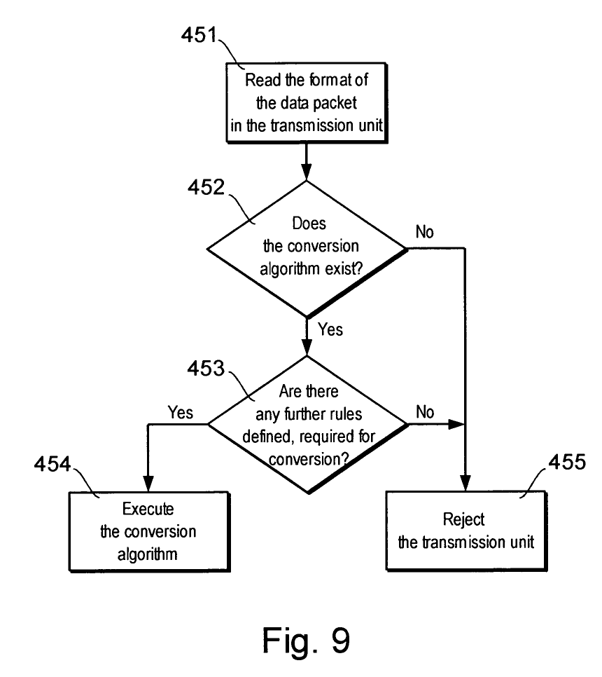

FIG. 7 of the drawing shows the rules management algorithm. It starts from the first rule assigned for a given unit 401. The rule is read 402 and commands defined by the rule are executed. If there is a conversion command defined in the rule, the algorithm shown in FIG. 9 is performed, otherwise the algorithm shown in FIG. 8 is performed. Next, a check is made whether as an outcome of applying the rule the unit has been split into a number of smaller units 404 and if the currently executed rule does not concern conversion. If both conditions are fulfilled, the rule is performed for the subsequent units 405. Then the procedure checks whether there are any further rules for the current unit (or the units created after current unit splitting) 406. If there are, they are performed in 407. If there are no more rules, the rules management for a given unit is finished 408.

FIG. 8 presents an algorithm of execution of commands defined by rules, except the rules with conversion command, for which the algorithm is presented in FIG. 9. First a rule is read 421, followed by reading transmission unit information 422. Then a check is made whether the unit type allows execution of the action defined by the rule 423 (for example, when the rule applies to change of identification data, a check is made whether there are specific identification data in the unit). If it does, the action defined by the rule is performed 424 (for example, a change of packet identification data or removal of a packet). This completes the execution of commands for a given unit.

FIG. 9 presents a method of conversion of packets encapsulated in transmission units. The procedure described below is invoked by a Convert command. In its first step the procedure reads the format of the input packet 451. Then, a check is made whether there is an algorithm that converts packets of an input format to an output format defined for the node 452. If not, the packet is rejected 455. Otherwise, the procedure checks whether a given algorithm requires the presence of any further rules, and if it does then it checks whether these rules are defined 453 (for example, there may be a rule required that assigns a specific value to a given field of a packet header). If the check fails, the unit is rejected. Otherwise, the conversion algorithm is executed 454. The actions of the conversion algorithm depend on the conversion type and are outside of the scope of this description. The conversion may involve a change of data that a transmission unit includes, an increase of unit size by adding zero bits or a split of the unit into smaller units. In case of a split, the unit header is assigned to every new packet according to the algorithm shown in FIG. 4 of the drawing.

The output nodes are responsible for the generation of a stream in an appropriate format. This is done in step 306 of the algorithm shown in FIG. 6, after the commands of the general rules and input rules for a given input have been performed.

The execution of functions of the output nodes is performed according to the procedure shown in FIG. 10 of the drawing. A transmission unit is read 501. Then, a packet is extracted from the unit and label, type and size fields are removed 502. The next step involves performing further actions on the packet, defined for a given output node (for example, conversion of the packet to a different format). After those actions are finished, the packet is ready for transmitting 504 and the procedure returns to step 309 of FIG. 6, where the packet is transmitted.

1. A method for control of data flow in a packet data transmission system based on filtering and performing actions on packets transmitted through a network, according to predetermined packet processing rules characterized in that to the data processing system comprising a network of nodes including input nodes (IN1-INn), output nodes (OUT1-OUTn) and intermediate nodes including data processing nodes (PROC1 PROCn) or multiplexers (MUX1-MUXo), data is supplied to the input nodes (IN1-INn) of the system, and from the data packets read from these nodes (IN1-INn) transmission units are formed, and each of the nodes is assigned input and output rules as well as general rules (R) and whenever a packet is available at the node input (PROC1-PROCn, MUX1-MUXo, OUT1-OUTn), a check is made whether the general rules apply to a given unit, and in case of a positive result of this check, the commands, determined by these rules, are executed, and then a check is made whether the input rules of the given node apply to a given unit and if they do, the commands, determined by these rules, are executed and then the node (IN1-INn, PROC1-PROCn, MUX1-MUXo, OUT1-OUTn) functions are preformed and a check is made whether the output rules apply to a given unit and in case of a positive result of this check, the commands, determined by these rules, are executed, and then in the output nodes (OUT1-OUTn), the packets are extracted from transmission units, which are created by adding a label field, a type field and/or a size field to the packet and, when a rule is a conversion rule, a check is made whether a given conversion algorithm requires additional rules being present and if it does and the additional rules are not present, the packet is rejected and the packets to which the rule applies are defined by specifying their label, type, size or similar parameters.

2. The method according to claim 1, characterized in that in the input nodes (IN1-INn) the transmission units are assigned labels, which identify the input node (IN1-INn), which a given unit originates from.

3. The method according to claim 1, characterized in that the rules define a command assigning labels to a transmission unit and/or the rules define a filtering command the filtering being achieved by replacing packets of given transmission units with empty packets.

4. (canceled)

5. The method according to claim 1, characterized in that the rules define a transmission unit range filtering command, the filtering being achieved by replacing packets of transmission units within a given range with empty packets and/or the rules define a command for replacing identification fields of packets in units, the command being implemented by replacing values in given fields with different ones.

6. (canceled)

7. The method according to claim 1, characterized in that the rules define a keep-units command, the keeping being achieved by passing on only certain transmission units and replacing packets in the remaining transmission units with empty packets and/or by passing on only certain range of transmission units and replacing packets in the remaining transmission units with empty packets.

8. (canceled)

9. The method according to claim 1, characterized in that the rules define a skip-units command, the skipping being achieved by passing on only certain transmission units and deleting the remaining transmission units and/or by passing on only certain range of transmission units and deleting the remaining transmission units.

10. (canceled)

11. The method according to claim 1, characterized in that the rules define an assign command, the command being implemented by assigning a defined value to a predetermined packet identification field in all packets that the rule applies to and which comprise the identification field and/or the rules define a conversion command, the command being implemented by conversion of packets of transmission units from a given format to another predetermined format.

12-13. (canceled)

14. A method for control of data flow in a packet data transmission system provided with nodes having node-specific functions, the method comprising the steps of:
encapsulating packet data into transmission units at input nodes;
assigning rules to each node, the rules defining additional functions to be performed by the node and being one of general rules applying to all transmission units processed in the node, input rules applying to transmission units incoming at a specific input of the node and output rules applying to transmission units outgoing from a specific output of the node;
processing data in each node by performing sequentially the functions defined by general rules, the functions defined by the input rules, the node-specific functions and the functions defined by the output rules; and
decapsulating transmission units into packet data at the output nodes.

15. The method according to claim 1, wherein additionally a label is assigned to each transmission unit while encapsulating, the label identifying the input node, from which the transmission unit originates.

16. The method according to claim 1, wherein the rules define a label command, which causes assigning a label to each transmission unit.

17. The method according to claim 1, wherein the rules define a filter command, which causes replacing specific data packets in the transmission units with empty data packets.

18. The method according to claim 1, wherein the rules define a remap command, which causes remapping of specific values in a specific field within data packets in the transmission units.

19. The method according to claim 1, wherein the rules define a keep command, which causes passing transmission units with data packets having specific values of a specific field, and replacing data packets of all other transmission units with empty data packets.

20. The method according to claim 1, wherein the rules define a skip command, which causes passing transmission units with data packets having specific values of a specific field, and removing all other transmission units.

21. The method according to claim 1, wherein the rules define an assign command, which causes setting a specific field of packets in transmission units to a specific value.

22. The method according to claim 1, wherein the rules define a convert command, which causes converting a format of chosen packets in transmission units.

23. The method according to claim 9, further comprising the steps of:
checking if in the nodes exist a specific conversion algorithm and further rules required for conversion of the chosen data packets, the checking made prior to converting the format of the chosen data packets in the transmission units;
executing the specific conversion algorithm if the specific conversion algorithm and further rules required for conversion of the chosen data packets exist in the nodes; and
rejecting the transmission unit if no specific conversion algorithm and further rules required for conversion of the chosen data packets exist in the nodes.

24. A device for data flow control in a packet data transmission system, the device comprising:
input nodes, having node-specific functions related to encapsulating incoming data packets into transmission units;
intermediate nodes, having node-specific functions related to processing transmission units, whose inputs are connected to the outputs of the input nodes or other intermediate nodes;
output nodes, having node-specific functions related to decapsulating transmission units into outgoing data packets, whose inputs are connected to the outputs of the input nodes or intermediate nodes,
wherein the input nodes, the intermediate nodes and the output nodes have assigned rules, the rules defining additional functions to be performed by the input nodes, the intermediate nodes and the output nodes and being one of general rules applying to all transmission units processed in the node, input rules applying to transmission units incoming at a specific input of the node, and output rules applying to transmission units outgoing from a specific output of the node, and wherein the priority of performing node-specific and rule-defined functions while processing data incoming to each node is defined in the following order, starting from the highest priority: functions defined by general rules, functions defined by input rules, node-specific functions and functions defined by output rules.

25. The device according to claim 24, wherein the intermediate nodes are data processing nodes and multiplexers.

26. The device according to claim 24, wherein each of the transmission units consists of a header and a data packet, and the header comprises a label, defining the input node, from which a given transmission unit originates.
